(19) United States
(12) Patent Application Publication
(10) Pub. No.: US 2017/0266067 A1
(43) Pub. Date: Sep. 21, 2017

(54) Vibration-Damping Spineboard Securing System

(71) Applicant: Innex Technologies, Inc., Norwich, VT (US)

(72) Inventors: Michael H. Holland, Norwich, VT (US); Bruce Williams, Grosse Point Park, MI (US)

(21) Appl. No.: 15/447,601

(22) Filed: Mar. 2, 2017

Related U.S. Application Data
(60) Provisional application No. 62/310,855, filed on Mar. 21, 2016.

(51) Int. Cl. A61G 1/01; A61G 1/04; A61G 1/044; A61G 1/048; A61G 1/003

(52) U.S. Cl. CPC A61G 1/01; A61G 1/048; A61G 1/003; A61G 1/044; A61G 1/042

(57) ABSTRACT

A pad of vibration-reducing foam is interposed between a spineboard and a litter that are secured together by straps. The pad has a pad upper surface contoured to receive and substantially mate with a spineboard lower surface to block horizontal motion therebetween, and a pad lower surface with a substantially planar support region. The pad can be formed of more than one layer of foam, with each layer having different vibration-damping characteristics. Material costs can be reduced by employing a discontinuous pad formed by a pad head segment and a pad foot segment. When a full-length pad is employed, separate straps for engaging the spineboard and the litter can be provided, with the pad interposed between the straps to prevent transmission of vibrations through the straps. The pad can be configured to offset the spineboard on the litter and allow a portable ICU to be placed alongside the spineboard.

### FIELD OF THE INVENTION

The present invention relates to spineboards employed to transport injured persons while protecting them from further injury during transport, and more particularly relates structure for supporting and securing a spineboard during transport.

### BACKGROUND OF THE INVENTION

Wounded personnel who have sustained back injury are frequently transported on a spineboard, such as those taught in U.S. Pat. Nos. 7,028,357 and D511,835 of the present applicant, incorporated herein by reference. Such spineboards are frequently placed into vehicles for transportation, either temporarily on a floor of the vehicle, or on a litter supported on stanchions provided in the vehicle for such purposes. It has been found that vibrations from the transport vehicle can be transmitted through the stanchions and litters to wounded personnel being carried, adversely affecting their health. Thus, there is a need for a system to reduce transmission of vibrations from the vehicle to the wounded personnel being transported therein.

### SUMMARY

The present invention provides a securing system for securely attaching a spineboard to a litter for transportation, while reducing transmission of vibrations from the litter to the spineboard, and thus to a wounded patient supported on the spineboard. The spineboard with which the system is intended for use has a contoured spineboard lower surface having a ground-engaging structure designed for supporting the spineboard on an underlying surface. The ground-engaging structure may include a pair of runners connected by an arched structure that provides increased rigidity, such as taught in U.S. Pat. No. 7,028,357. The ground-engaging structure terminates in ground structure ends. The spineboard has a spineboard upper support surface for supporting a patient being transported, and which typically extends beyond the ground structure ends. Handholds are disposed about the spineboard upper surface to facilitate grasping the spineboard by medical personnel, and typically also serve as anchoring structures to which straps can be attached to secure the patient to the spineboard. The ground-engaging structure raises the handholds off the underlying surface to facilitate grasping the spineboard.

The spineboard securing system of the present invention has a pad formed from vibration-damping foam, which has a pad upper surface that is contoured to receive and substantially mate with the spineboard lower surface. This contour causes the pad upper surface to engage the ground-engaging structure of the spineboard to block horizontal motion therebetween. Where the ground-engaging structure of the spineboard has runners, the pad upper surface has corresponding troughs to receive the runners so as to prevent lateral motion, and can also have pad end ledges that are positioned beyond the ends of the runners to block longitudinal motion.

The pad also has a pad lower surface, having at least one substantially planar support region for resting on a horizontal surface such as a litter. For temporary transportation, the pad lower surface can be rested on the floor of a vehicle. The separation between the pad lower surface and the pad upper surface should be set to assure a minimum thickness of the pad even in the troughs; a thickness of about 1¼ inches (31 mm) is felt to be an effective minimum. The pad could be molded to the desired shape, or milled to shape from flat stock when the foam employed for the pad is readily machinable. The width of the pad may be selected to substantially span the width of the litter with which the pad is intended to be used, in order to align the pad and spineboard attached thereto on the litter to prevent shifting during transportation. As discussed below, the pad may be designed to position the spineboard off-center on the litter.

To enhance the vibration-damping action of the pad, it is preferred for the pad to be composed of at least a first foam layer and a second foam layer, where the vibration-damping response of each layer is different. This allows each layer to be selected to more effectively damp vibrations of a particular amplitude and frequency range, as vibrations typically experienced during transport that are outside the range best damped by one layer will be better damped by a different layer. The layers should be positioned such that each layer extends continually across at least the extent of the pad that underlies the portion of the spineboard that engages the pad upper surface; typically, each layer extends entirely across the width of the pad. A gel layer such as those known in the art for reducing transmission of impacts could be incorporated into the pad to further reduce vibration transmission through the pad; again, the gel layer should extend at least across the portion of the pad underlying the region that directly engages the spineboard lower surface.

The spineboard securing system also has an arrangement of straps to secure the spineboard to a litter with the pad interposed therebetween. In a simple scheme, a conventional arrangement of straps can be employed where straps secure the spineboard directly to the litter after the spineboard lower surface has been mated against the pad upper surface and the pad lower surface has been rested on the litter. This allows existing straps to be employed in a conventional manner, but with the pad interposed between the spineboard and the litter. However, this may result in vibrations being transmitted from the litter to the spineboard via the straps, and thus expose the patient to an undesirable degree of vibration. This vibration could be reduced by employing a vibration-damping foam between the straps and the spineboard and/or between the straps and the litter, but the effectiveness of such foam would be limited by the available thickness that could be employed while still allowing the straps to be readily attached. For many applications, the advantages of simplicity and familiarity in using a conventional strap arrangement outweigh the possibility of vibration transmissions through the straps.

An alternative arrangement of straps for the present system is an arrangement that employs separate straps for securing the pad to the spineboard and for securing the pad to the litter, thereby preventing transmission of vibrations directly through the straps from the litter to the spineboard. One such arrangement employs a pair of spineboard-engaging straps that are spaced apart longitudinally and partially reside in spineboard strap channels recessed into the pad lower surface, connected together by one or more longitudinal straps. The spineboard-engaging straps extend beyond the pad sufficiently to securely engage opposed handholds of the spineboard, and have spineboard-engaging strap closures such as side-release buckles that secure the spineboard-engaging straps after encircling the handholds. Notches can be provided in the sides of the pad to prevent tension in the spineboard-engaging straps from bending the pad upwards off the litter. One or more litter-engaging straps are also provided, each residing partially in a litter-engaging strap channel recessed into the pad upper surface, the litter-engaging strap channel(s) being recessed sufficiently deeply so as to position the litter-engaging strap(s) at an elevation that avoids interference with mating the ground-engaging structure of the spineboard with the pad upper surface. Each litter-engaging strap extends beyond the pad a sufficient length to wrap about a portion of the litter, and has a litter-engaging strap closure such as a side-release buckle that can be operated to secure the litter-engaging strap to the litter. In this arrangement, portions of the pad are interposed between the spineboard-engaging straps and the litter-engaging strap(s), thereby damping vibrations to reduce transmission from the litter to the spineboard through the straps. The litter-engaging strap(s) should be positioned to pass over the longitudinal strap(s), providing a secure connection between the litter and the spineboard in the event that the foam is damaged, thereby preventing the spineboard from becoming dislodged from the litter in the event that the vehicle experiences severely uneven motion such as air turbulence. It should be appreciated that the placement of the straps could be reversed, such as by employing a pair of litter-engaging straps connected together by one or more longitudinal straps and positioning the spineboard-engaging straps to pass under the longitudinal strap(s).

To reduce material costs, the pad could be formed as a discontinuous pad, having only a head segment and a foot segment, each of which is interposed between a corresponding portion of the spineboard and the underlying litter. In such cases, each segment needs to have a sufficient length to supportably engage the spineboard and to provide sufficient frictional engagement to remain in place when the spineboard is secured to the litter by the strap arrangement. While the use of a discontinuous pad reduces material costs, it may complicate use of the system by increasing the number of parts that must be manipulated to properly arrange the spineboard on the litter with the pad interposed therebetween.

As noted above, the pad is frequently designed to position the spineboard offset with respect to the litter. This offset provides a space on the litter alongside the spineboard to allow a portable ICU (such as the MOVES® system offered by Thornhill Research Inc. of Toronto, ON, Canada) to be placed on the litter alongside a portion of the spineboard. The portable ICU may rest upon a shelf formed by the pad, or the pad can include a cutout to accommodate the portable ICU.

Since litters are frequently used for wounded personnel who are not supported on a spineboard, it is desirable to store the spineboard-securing system when not needed. One convenient approach to storing the system is to provide a fluid-impermeable storage bag that is sized to accept the pad with the arrangement of straps attached thereto. The storage bag can be secured to the underside of a litter by an arrangement of storage bag straps to position the stored pad beneath the litter, leaving the upper side of the litter unobstructed for use. The impermeable-character of the storage bag protects the stored pad enclosed therein from being contaminated by fluids leaking through the litter during use.

### BRIEF DESCRIPTION OF FIGURES

FIGS. 1-4 illustrate a vibration-damping spineboard securing system that forms one embodiment of the present invention. FIGS. 1 and 2 illustrate the system prior to its use to secure a spineboard to a litter, with FIG. 1 being an upper isometric view and FIG. 2 being a lower isometric view. FIG. 3 illustrates the system when in use. The system has a pad with a pad upper surface, which is configured to mate against a spineboard lower surface of the spineboard, and a pad lower surface, which is substantially planar to rest atop the litter or to rest directly on a vehicle floor. Straps are provided that pass over the spineboard and wrap below the litter to secure the spineboard thereto with the pad interposed between the litter and the spineboard (as shown in FIG. 3).

FIG. 4 is a view of the section 4-4 of FIG. 1, better illustrating the contours of the pad upper surface and a shelf formed on the pad by offsetting the spineboard on the pad, allowing space for a portable ICU to be placed on the pad alongside the spineboard (as shown in FIG. 3). FIG. 4 also illustrates a layered structure employed in the pad, which has two layers of foam having differing vibration-damping characteristics.

FIGS. 5 and 6 are section views that correspond to the view of FIG. 4, showing alternative structures for the pad. FIG. 5 illustrates a pad having a third layer of foam, with a vibration damping characteristic different from the responses of the first and second layers, while FIG. 6 illustrates a pad having a similar structure, with the addition of a gel layer underlying the portion of the pad upper surface that engages the spineboard when the pad is in use.

FIGS. 7-9 illustrate a spineboard securing system similar to that shown in FIGS. 1-4, but where the pad employed is a discontinuous pad having a head segment and a foot segment. Each segment has a contoured segment upper surface configured to mate against a corresponding portion of the spineboard lower surface. FIG. 9 shows one example of how straps can be employed to secure the spineboard to the litter, with the pad interposed therebetween with its lower surface resting on an upper surface of the litter.

FIGS. 10-13 illustrate a vibration-damping spineboard securing system that forms another embodiment of the present invention, and which is designed to prevent transmission of vibrations through the straps from the litter to the spineboard. FIG. 10 is a lower view that illustrates the system prior to use. In this embodiment, an arrangement of straps is employed that has a pair of spineboard-engaging straps and a separate pair of litter-engaging straps. The spineboard-engaging straps are connected together by longitudinal straps, and pass under the pad, while the litter-engaging straps pass over the pad and over the longitudinal straps. The lower view of FIG. 10 shows channels that are provided in a pad lower surface to accommodate the spineboard-engaging straps that secure the pad to the spineboard.

FIG. 11 illustrates the system shown in FIG. 10 when spineboard has been mated against the pad upper surface of the pad and in turn secured to the litter. The spineboard-engaging straps encircle and secure to handholds on the spineboard, while the litter-engaging straps encircle and secure to the litter. The straps are separated and do not contact each other.

FIG. 12 is a view of the pad and spineboard at the section 12-12 shown in FIG. 11, illustrating further details of the pad and its interaction with the spienboard-engaging straps. As illustrated, the pad is formed from a single piece of foam.

FIG. 13 is an upper view showing the pad employed in the system shown in FIGS. 10 and 11, with the straps omitted for clarity to better illustrate the structure of the pad. The pad has a pad upper surface that is configured to mate against the spineboard, and which is provided with channels to accommodate the litter-engaging straps that secure the pad to the litter, passing over longitudinal straps that conned the spineboard-engaging straps together (as shown in FIG. 10).

### DETAILED DESCRIPTION

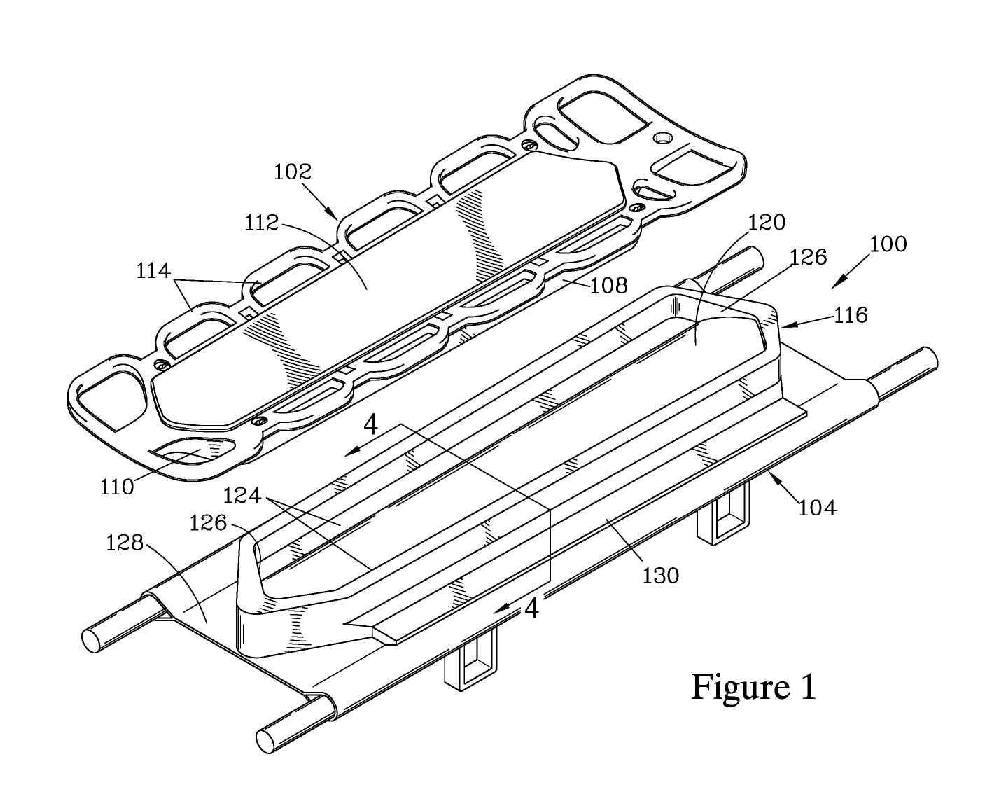

FIGS. 1-4 illustrate a vibration-damping spineboard securing system 100 that serves to securely position a spineboard 102 on a litter 104 and to reduce transmission of vibrations from the litter 104 to the spineboard 102.

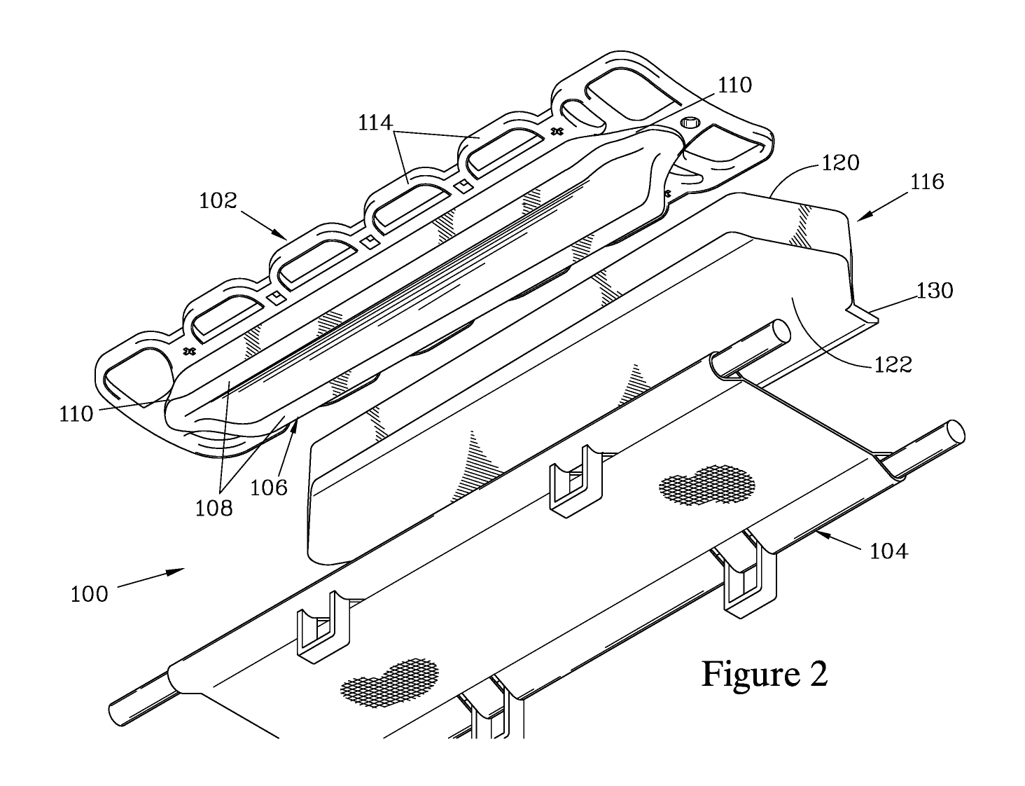

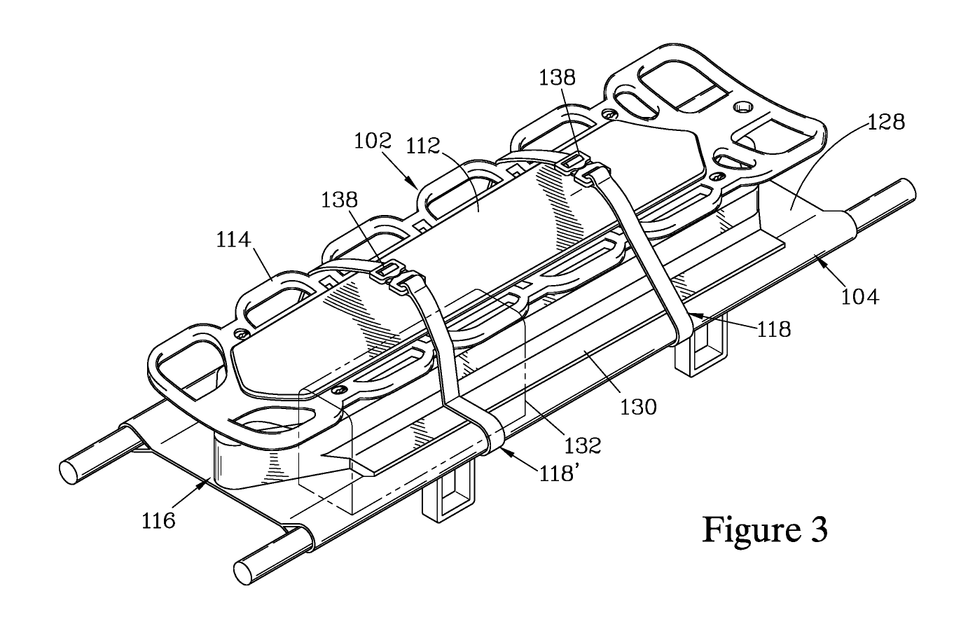

The spineboard 102 has a spineboard lower surface 106 (shown in FIG. 2) that is contoured to provide a pair of spineboard runners 108 designed for supporting the spineboard 102 on an underlying surface, as well as providing rigidity for the spineboard 102; such spineboards are taught in U.S. Pat. Nos. 7,028,357 and D511,835. One available spineboard 102 is the RescuePad™ critical care patient transportation platform offered by Emergency Products & Research, Inc., of Kent Ohio. The spineboard runners 108 serve as a ground-engaging structure of the spineboard 102, and terminate at ground structure ends 110. The spineboard 102 has a spineboard upper support surface 112 (shown in FIGS. 1 and 3), on which a patient being immobilized for transportation may be placed, and an array of handholds 114 arranged about the spineboard upper surface 112 to enable medical personnel to firmly grasp the spineboard 102. The contour of the spineboard lower surface 106 serves to raise the handholds 114 off the underlying surface to further facilitate grasping.

The spineboard securing system 100 has a pad 116 and an arrangement of straps 118 (shown in FIG. 3). The pad 116 resides atop the litter 104 and receives the spineboard 102, while the straps 118 serve to connect the spineboard 102 with respect to the litter 104 to maintain the spineboard 102 in place in the event that the litter 104 is subject to uneven motion, such as in an aircraft experiencing turbulence.

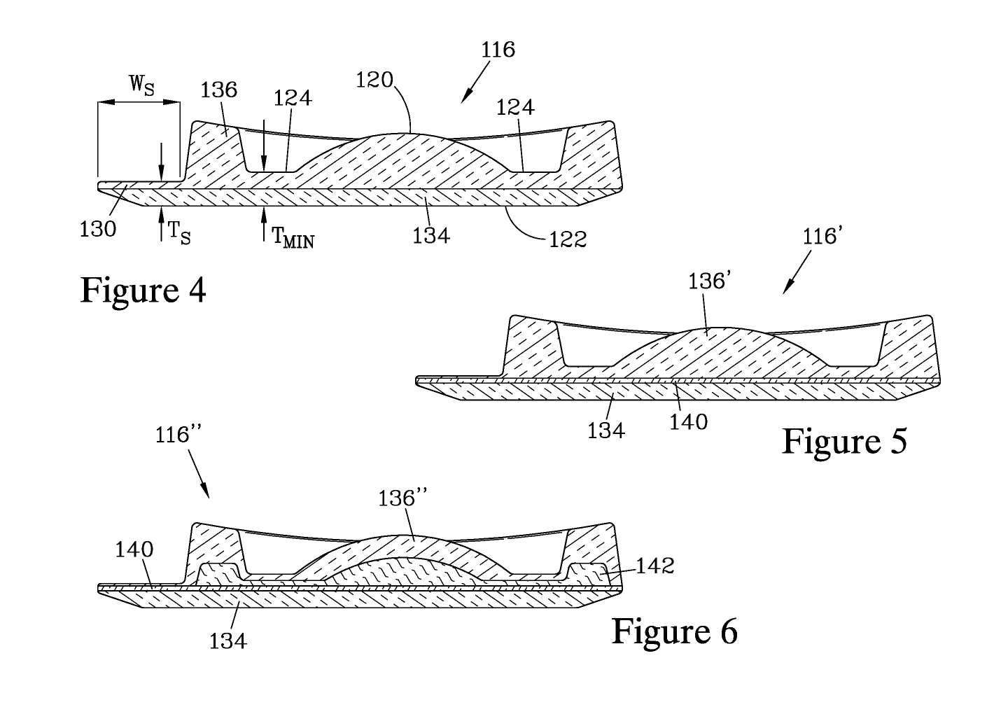

The pad 116 is formed of vibration-reducing foam material such as vinyl nitrile. The pad 116 has contoured a pad upper surface 120 (shown in FIG. 1) and a substantially planar pad lower surface 122 (shown in FIG. 2). The pad upper surface 120 is configured to receive and at least partially mate against the spineboard lower surface 106 when the spineboard 102 is placed atop the pad 116. In the pad 116, the pad upper surface 120 is provided with a pair of upper surface troughs 124 (best showing in FIG. 4) that are configured to accept the spineboard runners 108. The mateable engagement between the spineboard runners 108 and the upper surface troughs 124 blocks lateral movement of the spineboard 102 relative to the pad 116. The upper surface troughs 124 terminate at pad end ledges 126 that bracket the ground structure ends 110 of the spineboard runners 108, thereby blocking longitudinal movement of the spineboard 102 relative to the pad 116.

The pad lower surface 122 is substantially planar, providing a planar support region that provides stability for the pad 116 and the spineboard 102 when the pad 116 is placed on a horizontal surface, such as a vehicle floor for temporary transportation of a patient. When the system 100 is employed to secure the spineboard 102 to the litter 104, the pad lower surface 122 is placed onto a litter upper surface 128 of the litter 104 (shown in FIGS. 1 and 3). When designed for use with standardized litters, the pad lower surface 122 typically has a width selected relative to that of the litter upper surface 128 so as to align the pad 116 with the litter 104 when placed thereon. For example, for one embodiment where the litter 104 has an overall width of 544 mm, the pad 116 has a width of 481 mm; this pad 116 has an overall length of 1804 mm.

The pad lower surface 122 is separated from the upper surface troughs 124 by a minimum effective thickness T_{MIN} (shown in FIG. 4). Preferably, the minimum effective thickness T_{MIN} that separates the spineboard runners 108 from the litter 104 during use is at least about 1¼ inches (about 31 mm). The foam material selected for the pad 116 should be relatively rigid, so as to firmly position the spineboard 102, while having sufficient vibration-damping character to reduce transmission of vibrations from the litter 104 to the spineboard 102. One example of such a material is Cellflex® EVA190 foam available from Der-Tex Corp. of Saco, Me., which is described as a crosslinked closed-cell EVA-based polyolefin foam, having a density of 1.5-2.5 PCF and a Shore 00 durometer of about 44. As discussed below, it is preferred to employ a layered structure employing foam materials having differing vibration-damping characteristics.

The pad upper surface 120 is configured with the upper surface troughs 124 off-center relative to the pad lower surface 122, such that the spineboard 102 is positioned offset to one side with respect to the litter 104 when placed thereon. This offset forms a shelf 130 alongside the spineboard 102, which can accommodate a portable ICU device 132 attached to the litter 104 alongside the spineboard 102, as shown in FIG. 3. One such portable ICU is the as the MOVES® system offered by Thornhill Research Inc. of Toronto, ON, Canada. When the pad 116 has the dimensions set forth above, it has been found effective to offset the spineboard 102 about 54 mm relative to the litter, providing the shelf 130 with a shelf width W_{S} of about 62 mm (shown in FIG. 4). The shelf 130 can be formed with a shelf thickness T_{S} of about 21 mm.

While the pad 116 could be formed from an integral piece of foam, enhanced ability to damp vibrations can be provided by employing a layered structure, as shown in FIG. 4. The pad 116 is formed from a first foam layer 134, extending upwards from the pad lower surface 122, and a second foam layer 136, extending downward from the pad upper surface 120. Each of the foam layers (134, 136) has different vibration-damping characteristics in order to absorb wide ranges of amplitude and frequencies of vibrations and impacts. A softer foam can be employed for the first foam layer 134 to reduce higher frequency and/or lower amplitude forces transferred to the patient on the spineboard 102. A harder foam can be employed for the second foam layer 136 to provide rigidity in the contoured pad upper surface 120 to hold the spineboard 102 in place, while also reducing lower frequency and/or higher amplitude forces transferred to a patient. The laminated foam structure provides a dual-density character to the pad 116 to absorb a wide range of forces and energies. The thickness of the foam layers (134, 136) should be selected such that both layers (134, 136) extend continuously across the pad 116 at least in the region underlying the spineboard lower surface 106, and have a roughly equal thickness at the point of minimum effective thickness (T_{MIN}) of the pad 116 in the location of the upper surface troughs 124. For example, where minimum effective thickness T_{MIN} measures about 1¼ inches (or about 31 mm), each of the foam layers (134, 136) should have a thickness in the location of the upper surface troughs 124. In one example, the pad 116 was formed with the first foam layer 134 being formed of ⅝ inch (16 mm) thick high-density vinyl nitrile (VN), and the second foam layer 136 being formed of ethylene-vinyl acetate (EVA) foam having a minimum thickness of ⅝ inch (16 mm) in the upper suraface troughs 124, and a maximum thickness of 2⅞ inches (73 mm), providing the pad 116 with a total maximum thickness of 3½ inches (89 mm). One suitable material for the first foam layer 134 is Cellflex® Impax® VN 740 vinyl nitrile foam available from Der-Tex Corp. of Saco, Me. (listed as having a density of 7.34-8.74 PCF/0.12-0.14 g/cm³ and a Shore OO hardness of 60-80/Asker C hardness of 40-55), while a suitable material for the second foam layer 136 is the EVA190 foam discussed above.

As shown in FIG. 3, after the pad 116 has been placed onto the litter 104 and the spineboard 102 placed onto the pad 116, the straps 118 are employed to secure the spineboard 102 with respect to the litter 104. Such straps 118 are known in the art and are commercially available. In some cases, the straps 118 encircle the patient, spineboard 102, and litter 104 and secure their ends together using strap closures 138 to form a closed loop that can then be tightened to firmly secure the patient and spineboard 102 to the litter 104. One example of such straps are the Sked-Evac® litter straps (NSN: 6530-01-536-4145) offered by Skedco, Inc. of Tualitin, Oreg.; these straps are the subject matter of U.S. Pat. No. 7,752,722, incorporated herein by reference. An alternative scheme is to employ straps having anchoring ends that secure to longitudinal members of the litter 104, and free ends that fasten together over the patient and spineboard 102; again, once the free ends have been secured together, the straps 118 can be tightened to firmly secure the patient and spineboard 102 to the litter 104. Examples of straps that secure to longitudinal members of the litter 104 the Tactical Patient Restraint strap (NSN 6530-01-626-0965) and COBRA Restraint strap offered by Ferno Military Systems, Inc., of Alpharetta, Ga.; and the CASEVAC™ litter strap (NSN 6530-01-515-7918) offered by AWS, Inc., of Fayetteville, N.C. In either case, when such conventional straps are employed in the present invention to provide the straps 118, tightening of the straps 118 acts on the spineboard 102 to apply a compressive load on the pad 116 that is trapped between the spineboard 102 and the litter 104, thereby forcibly engaging the spineboard lower surface 106 against the pad upper surface 120, and forcibly engaging the pad lower surface 122 against the litter upper surface 128. When the portable ICU 132 is employed, the strap 118′ underlying the portable ICU 132 should have sufficient adjustability to accommodate being deflected by the portable ICU 132 when the portable ICU 132 is secured to the litter 104. While two commercially available arrangements of straps are discussed above, it should be appreciated that alternative straps that are capable of securing the spineboard 102 to the litter 104 and being tightened to apply a compressive load on the pad 116 could be employed.

Typically, the strap closures 138 that serve to secure the free ends of the straps 118 together are provided by adjustable buckles having mating elements that can be manually connected or disconnected, and which also provide the ability for the user to adjust the length of the strap 118. The adjustability allows each of the straps 118 to be readily secured around the spineboard 102 while somewhat loose, and subsequently tightened by pulling on an exposed end of the strap 118 to firmly secure the spineboard 102 and pad 116 to the litter 104 with a compressive force applied to the pad 116 to help secure it in place.

While the pad 116 employs two layers (134, 136) of foam, in some cases it may be desirable to employ a greater number of layers, each selected for its suitability to damp vibrations in a particular range of amplitude and/or frequency. FIG. 5 illustrates a pad 116′ that is formed similarly to the pad 116, with the first foam layer 134 again being formed of ⅝ inch (16 mm) thick high-densityVN 740 foam, but with the second foam layer 136′ being formed of EVA foam having a maximum thickness of 2⅝ inches (67 mm), which is ¼ inch (6 mm) thinner than the second foam layer 136. This reduced thickness accommodates a third foam layer 140 formed of ¼ inch (6 mm) thick softer foam, which is interposed between the first foam layer 134 and the second foam layer 136′; one suitable material for the third foam layer 140 is Cellflex® Impax® VN 4005 foam available from Der-Tex Corp. of Saco, Me. (listed as a closed cell PVC NBR rubber foam having a density of 3.0-4.5 PCF/0.05-0.07 g/cm³ and a hardness of less than 10 Shore OO).

FIG. 6 illustrates another alternative pad 116″, which further reduces transmission of vibrations by incorporating a gel layer 142. As illustrated, the gel layer 142 is interposed between a portion of the third foam layer 140 and the second foam layer 136″, and extends across the portion of the pad 116″ that underlies the spineboard lower surface 106. While the gel layer 142 could extend entirely across the width of the pad 116″, extending only across the portion underlying the spineboard lower surface 106 allows the second and third foam layers (136′, 140) to be bonded together at their edges for greater strength. Suitable gel materials are known in the art, such as the gel materials employed for reducing shock and vibration in footwear. It should be appreciated that a gel layer could be otherwise incorporated into a pad, including pads where only one of two foam layers are employed.

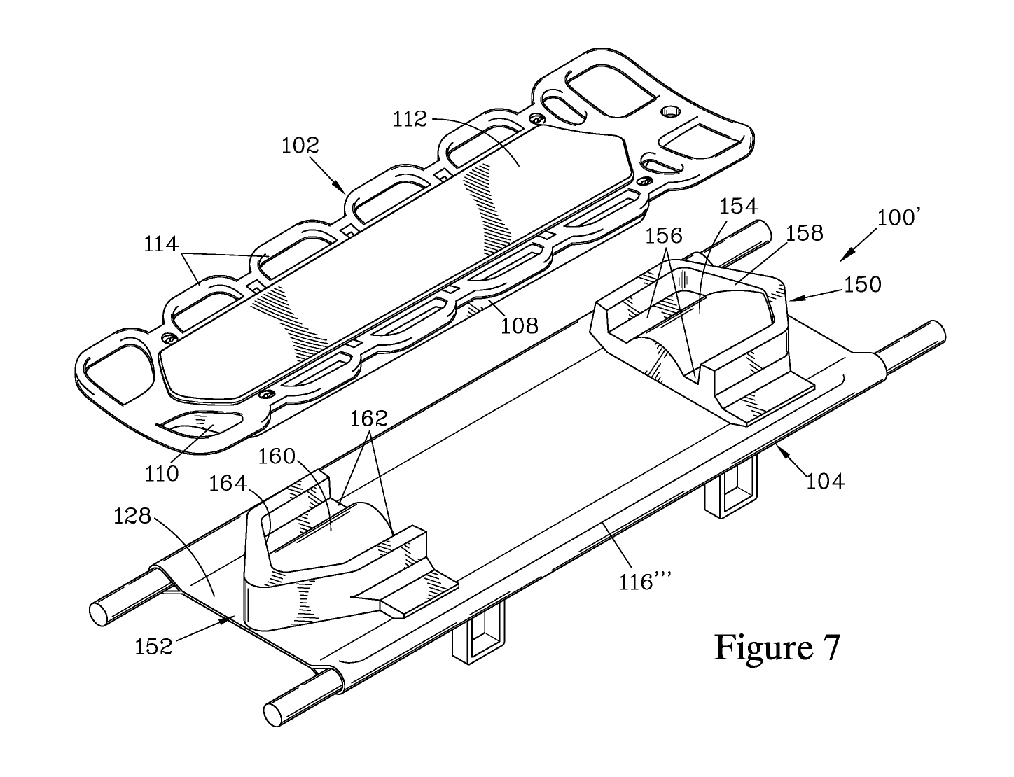

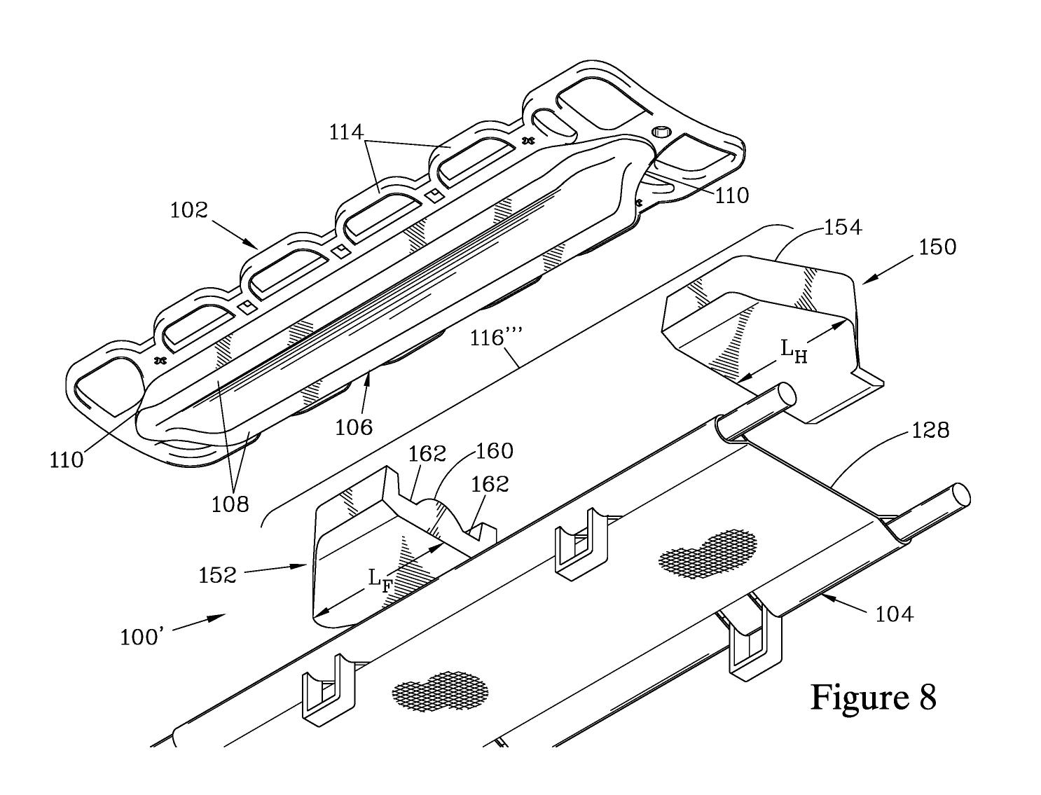

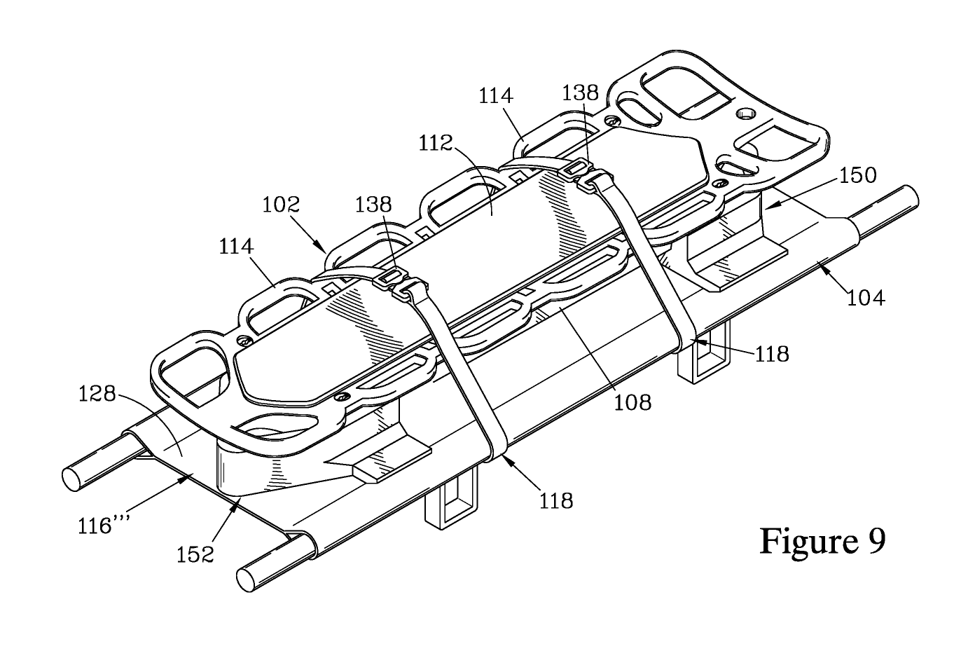

FIGS. 7-9 illustrate a vibration-damping spineboard securing system 100′ that is functionally similar to spineboard securing system 100 discussed above, but where the pad 116′″ is discontinuous to reduce material cost. FIGS. 7 & 8 show the pad 116′″, spineboard 102, and litter 104 spaced apart, while FIG. 9 shows the system 100′ in use with the straps 118 securing the spineboard 102 to the litter 104 with the pad 116′ interposed therebetween.

The pad 116′ has a pad head segment 150 and a pad foot segment 152, each of which is configured to mate against a portion of the spineboard lower surface 106; the structure of the pad 116′″ is essentially the same as that of the pad 116 shown in FIGS. 1-4, but with the central region of the pad 116 removed, leaving only the ends.

The pad head segment 150 has a head segment upper surface 154 that is provided with a pair of head segment troughs 156 configured to accept a portion of the spineboard runners 108, and is formed with a head segment ledge 158 that abuts against one of the ground structure ends 110. The pad head segment 150 has a head segment length L_{H} that is selected to provide a sufficient frictional engagement with the spineboard lower surface 106 and the litter upper surface 128 as to prevent the pad head segment 150 from becoming dislodged during use. In one embodiment, a head segment length L_{H} of about 10 inches (254 mm) was felt to be sufficient. In some cases, it may be desirable to apply a surface treatment to the pad head segment 150 to increase the friction where it engages the litter upper surface 128 and the spineboard lower surface 106.

Similarly, the pad foot segment 152 has a foot segment upper surface 160 having a pair of foot segment troughs 162, configured to accept a portion of the spineboard runners 108, and a foot segment ledge 164, configured to abut against the other of the ground structure ends 110. The pad foot segment 152 has a foot segment length L_{F} selected to provide sufficient frictional engagement to maintain the pad foot segment 152 in place during use. A foot segment length L_{F} of about 8½ inches (216 mm) was felt to be sufficient in one embodiment. Again, it may be desirable to apply a surface treatment to the pad foot segment 152 to increase the friction.

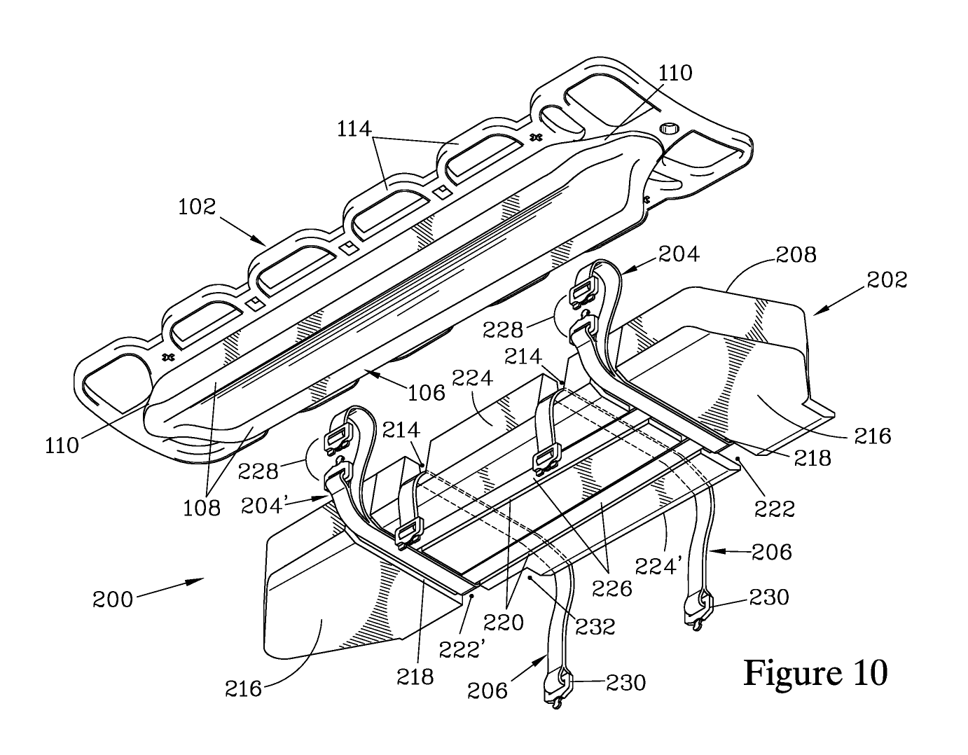

FIGS. 10-13 illustrate a vibration-damping spineboard securing system 200 that forms another embodiment of the present invention, and which is designed to provide further reduction in transmission of vibrations from the spineboard 102 to the litter 104. The system 200 again employs a pad 202 and an arrangement of straps to secure the spineboard to the litter 104 with the pad 202 interposed therebetween; however, the system 200 has separate spineboard-engaging straps 204 and litter-engaging straps 206 to prevent transmission of vibrations through the straps (204, 206).

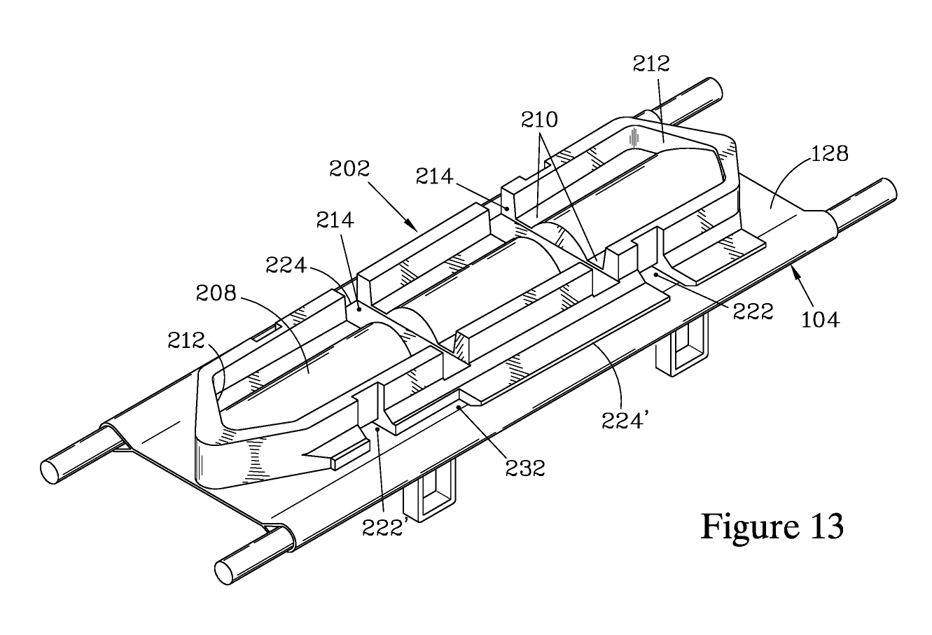

The pad 202 again has a contoured pad upper surface 208 (shown in FIG. 13) configured to accept the spineboard lower surface 106, having a pair of upper surface troughs 210 that mate against the spineboard runners 108 to block horizontal movement of the spineboard 102 relative to the pad 202, and pad end ledges 212. The pad upper surface 208 also has a pair of litter-engaging strap channels 214 that are recessed into the pad upper surface 208, in which a portion of the litter-engaging straps 206 reside. The litter-engaging strap channels 214 are recessed to a sufficient depth to place the litter-engaging straps 206 below the level of the upper surface troughs 210, so as to avoid blocking the spineboard runners 108 from entering the upper surface troughs 210. Preferably, the litter-engaging straps 206 are attached to the litter-engaging strap channels 214 to retain them in position when the system 200 is not in use; one means for attaching the litter-engaging straps 206 is by use of hook-and-loop fastener material, which can be sewn to the litter-engaging straps 206 and adhered to the litter-engaging strap channels 214. The litter-engaging strap channels 214 traverse the width of the pad 202. Again, the width of the pad 202 can be selected relative to the width of the litter 104 so as to align the pad 202 when placed onto the litter 104. In the pad 202, the pad upper surface 208 is again configured with the upper surface troughs 210 offset with respect to the width of the pad 202, rather than centered (as best shown in FIG. 12).

As shown in FIG. 10, the pad 202 has a pad lower surface 216 that is substantially planar, but which has a pair of recessed spineboard-engaging strap channels 218, connected by a pair of recessed longitudinal strap channels 220. The spineboard-engaging strap channels 218 terminate at strap notches 222 that are provided in side edges 224 of the pad 202, located to match the locations of the handholds 114 of the spineboard 102. As shown in FIG. 12, the strap notches 222 can be cut deep enough to extend inwards from the side edges 224 to points directly under the upper surface troughs 210, where pressure applied from above by the spineboard runners 108 acts to prevent tension in the spineboard-engaging straps 204 from bending the foam material of the pad 202 upwards. Again, it is preferred for the spineboard-engaging straps 204 to be attached to the spineboard-engaging strap channels 218, such as with strips of hook-and-loop fastener material.

The pad 202 illustrated is fabricated from an integral piece of foam, as shown in the section view of FIG. 12. It should be appreciated that the pad 202 could be formed with layers, in the same manner as the pads 116, 116′, and 116″ shown in FIGS. 4-6 and discussed above, to enhance the damping of vibrations.

As noted above, the system 200 employs separate spineboard-engaging straps 204 and litter-engaging straps 206. As shown in FIG. 10, the spineboard-engaging straps 204 are further connected together by a pair of longitudinal straps 226, which reside in the longitudinal strap channels 220 recessed into the pad lower surface 216. The litter-engaging strap channels 214 are positioned on the pad 202 so as to be bracketed by the spineboard-engaging strap channels 218, such that the litter-engaging straps 206 pass over the longitudinal straps 226 to provide a secure connection of the spineboard 102 to the litter 104 that is not dependent on the structural integrity of the pad 202.

The spineboard-engaging straps 204 extend beyond the spineboard-engaging strap channels 218, and terminate in spineboard-engaging strap closures 228 that allow the spineboard-engaging straps 204 to encircle the handholds 114 of the spineboard 102 before the spineboard-engaging strap closures 228 are snapped securely together to connect the spineboard-enagaging strap 204 to the handhold 114, and thereby secure the pad 202 to the spineboard 102. The spineboard-engaging straps 204 and the spineboard strap closures 228 can be provided by materials and hardware similar to those employed in conventional straps employed to secure spineboards to litters, such as discussed above with regard to the straps 118. These straps are typically provided by 1.5″ (38 mm)-2″ (51 mm) wide nylon webbing equipped with adjustable metal or plastic buckles that serve to secure the free ends together and allow the length to be readily adjusted by pulling on a section of strap material extending from the adjustable buckle.

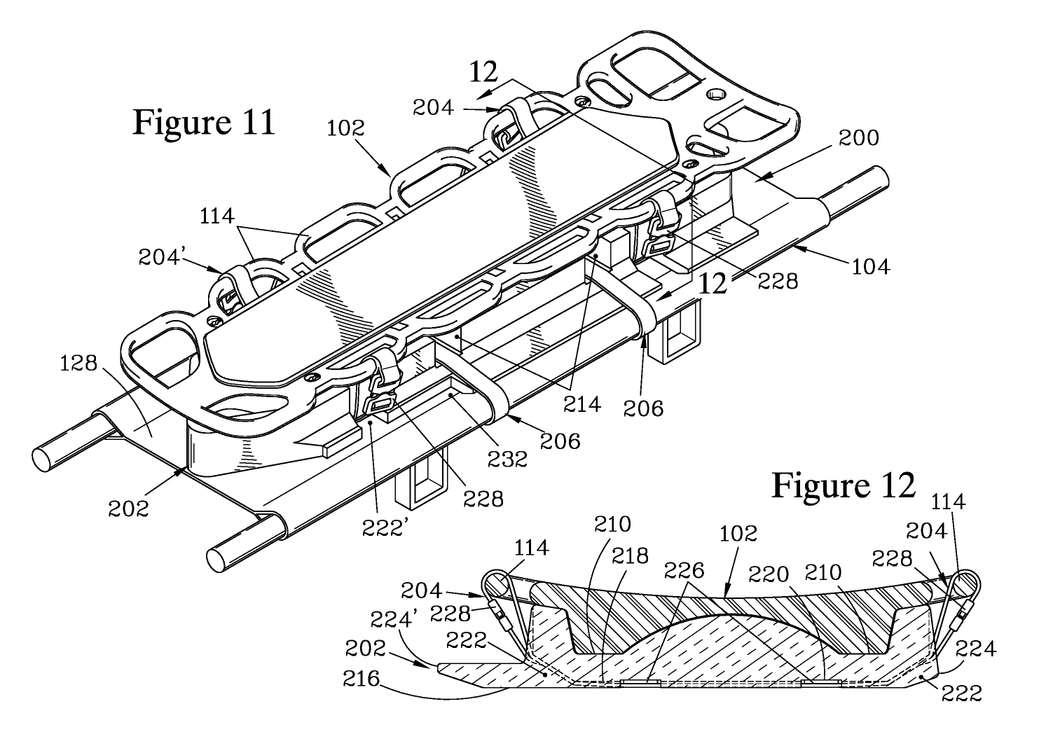

In a similar manner, each of the litter-engaging straps 206 extends beyond the litter strap channel 214 in which it partly resides and terminates in litter strap closures 230 (shown in FIG. 10), such as the mating components of an adjustable buckle. The litter-engaging straps 206 encircle the litter 104 and are secured thereabout by the litter strap closures 230 to secure the pad 202 to the litter 104 (as shown in FIG. 11. Since the pad 202 is in turn secured to the spineboard 102 by the spineboard-engaging straps 204, the spineboard 102 is secured to the litter 104, but there is no direct path through the straps (204, 206) along which vibrations can be transmitted from the litter 104 to the spineboard 102. Again, conventional materials and hardware can be employed for the litter-engaging straps 206 and the litter strap closures 230, and in some cases existing straps designed to encircle a spineboard and litter, such as those taught in U.S. Pat. No. 7,752,722, may be able to serve as the litter-engaging straps 206.

As noted above, the pad upper surface 208 is configured with the upper surface troughs 210 off-center, such that the spineboard 102 is positioned offset to one side with respect to the litter 104. In the pad 202, one of the side edges 224′ is provided with a portable ICU cutout 232 such that the pad 202 in the region of the cutout 232 does not extend beyond the footprint of the spineboard 102; the offset of the spineboard 102 increases the available space provided by the cutout 232. The cutout 232 allows a portable ICU device (such as the ICU device 132 shown in FIG. 3) to be positioned on the litter 104 alongside the spineboard 102. The adjacent strap notch 222′ serves to position the spineboard-engaging strap 204′ passing therethrough such that it is interposed between the portable ICU and the spineboard 102.

While the system of the present invention is advantageous in reducing vibrations transmitted to patients supported on a spineboard, litters are frequently used to transport patients who do not need to be immobilized, and thus are not supported on a spineboard. To accommodate such us of litters, it is desirable to provide means for conveniently storing the system of the present invention out of the way when not in use. One approach to storing the system is to provide a storage bag formed of an impermeable material, and sized to accept and enclose the pad (116, 202) of the system (100, 200) therein. The storage bag could be closed by a drawstring, zipper, snaps, hook-and-loop fastener, or similar means well known in the art. An arrangement of storage straps attached to the bag could be employed to strap the bag to the litter with the bag and enclosed system (100, 200) positioned below the litter, leaving the litter upper surface 128 free for use. Forming the bag from an impermeable material protects the enclosed system (100, 200) from contamination by liquids that may seep through the litter 104. The storage straps and related closures employed to secure the storage bag below the litter 104 can employ similar material and closure hardware as the straps (118, 204, 206) that are employed to secure the spineboard 102 to the litter 104, in order to provide familiarity for operators.

While the novel features of the present invention have been described in terms of particular embodiments and preferred applications, it should be appreciated by one skilled in the art that substitution of materials and modification of details can be made without departing from the spirit of the invention.

What is claimed is:

1. A vibration-damping spineboard securing system for temporarily securing a spineboard to a litter, the spineboard having,
a contoured spineboard lower surface having a ground-engaging structure designed for supporting the spineboard on an underlying surface,
a spineboard upper support surface for supporting a patient being transported,
handholds disposed about the spineboard upper surface to facilitate grasping the spineboard by medical personnel,
the spineboard securing system comprising:
a pad formed of vibration-reducing foam having a pad upper surface and a pad lower surface,
said pad upper surface being contoured to receive and substantially mate with the spineboard lower surface and to engage the ground-engaging structure so as to substantially block horizontal motion between the spineboard and said pad, and
said pad lower surface having at least one substantially planar support region for resting on a horizontal surface.

2. The spineboard securing system of claim 1 further comprising:
an arrangement of straps configured to secure the spineboard to the litter with said pad interposed therebetween when said pad lower surface resides on the litter.

3. The spineboard securing system of claim 1 wherein said pad further comprises:
a first layer of vibration-damping foam, and
a second layer of vibration-reducing foam, where the vibration-damping response of said first layer is different than the vibration-reducing response of said second layer, and where the interface between said first and second foam layers is located such that both layers are continuously interposed between the spineboard lower surface and the litter across the extent of said pad.

4. The spineboard securing system of claim 3 for use when the ground-engaging structure of the spineboard has spineboard runners and ground structure ends,
wherein said pad extends beyond each of the ground structure ends and said pad upper surface includes:
upper surface troughs for engaging the spineboard runners to block lateral motion of the spineboard on said pad upper surface, and
pad end ledges for engaging the ground structure ends to block longitudinal motion of the spineboard on said pad upper surface.

5. The spineboard securing system of claim 4 wherein said pad upper surface is configured to position the spineboard off-center with respect to a width of said pad, thereby providing space on the litter alongside the spineboard to accept a portable ICU.

6. The spineboard securing system of claim 3 wherein said pad further comprises:
a third layer of vibration-damping foam, where the vibration-damping response of said third layer is different than the vibration-reducing responses of said first and second layers, and where said third layer extends so as to be continuously interposed between the spineboard lower surface and the litter.

7. The spineboard securing system of claim 1 wherein said pad further comprises:
a pad head segment configured to mateably engage a first portion of the spineboard lower surface that underlies the head of a patient when in use; and
a pad foot segment configured to mateably engage a portion of the spineboard lower surface that is spaced apart from the portion engaged by said pad head segment and underlies the feet of a patient when in use.

8. The spineboard securing system of claim 1 further comprising:
a layer of vibration-reducing gel that extends so as to be continuously interposed between the spineboard lower surface and the litter.

9. The spineboard securing system of claim 2 wherein said arrangement of straps further comprises:
a pair of spineboard-engaging straps each having a section retained in a spineboard-engaging strap channel recessed into said pad lower surface and extending beyond said pad a sufficient length to wrap about an opposed pair of handholds of the litter, and having spineboard-engaging strap closures that are activatable to secure said spineboard-engaging strap about the handholds;
at pair of litter-engaging straps each having a section retained in a litter-engaging strap channel recessed into said pad upper surface and extending beyond said pad a sufficient length to wrap about the litter, and having a litter-engaging strap closure that is activatable to secure said litter-engaging strap about the litter; and
at least one longitudinal strap extending between and attached to one of said pair of spineboard-engaging straps and said pair of litter-engaging straps, which is spaced more widely apart than the other of said pair of spineboard-engaging straps and said pair of litter-engaging straps, said at least one longitudinal strap residing in at least one longitudinal strap channel recessed into said pad.

10. The spineboard securing system of claim 1 for use when the ground-engaging structure of the spineboard has spineboard runners and ground structure ends,
wherein said pad extends beyond each of the ground structure ends and said pad upper surface includes:
upper surface troughs for engaging the spineboard runners to block lateral motion of the spineboard on said pad upper surface, and
pad end ledges for engaging the ground structure ends to block longitudinal motion of the spineboard on said pad upper surface.

11. The spineboard securing system of claim 10 wherein said pad upper surface is configured to position the spineboard off-center with respect to a width of said pad, thereby providing space on the litter alongside the spineboard to accept a portable ICU.

12. A vibration-damping pad for supporting a spineboard on a litter when secured thereto with straps with the pad interposed between the spineboard and the litter, the spineboard having,
a contoured spineboard lower surface having a ground-engaging structure designed for supporting the spineboard on an underlying surface,
a spineboard upper support surface for supporting a patient being transported, handholds disposed about the spineboard upper surface to facilitate grasping the spineboard by medical personnel,
the pad being formed of vibration-reducing foam and comprising:
a pad upper surface contoured to receive and substantially mate with the spineboard lower surface and to engage the ground-engaging structure so as to substantially block horizontal motion between the spineboard and said pad; and
a pad lower surface having at least one substantially planar support region for resting on a horizontal surface.

13. The vibration-damping pad of claim 12 for use when the ground-engaging structure of the spineboard has spineboard runners and ground structure ends,
wherein said pad extends beyond each of the ground structure ends and said pad upper surface includes:
upper surface troughs for engaging the spineboard runners to block lateral motion of the spineboard on said pad upper surface, and
pad end ledges for engaging the ground structure ends to block longitudinal motion of the spineboard on said pad upper surface.

14. The spineboard securing system of claim 13 wherein said pad upper surface is configured to position the spineboard off-center with respect to a width of said pad, thereby providing space on the litter alongside the spineboard to accept a portable ICU.

15. The vibration-damping pad of claim 12 wherein the pad further comprises:
a first layer of vibration-damping foam, and
a second layer of vibration-reducing foam, where the vibration-damping response of said first layer is different than the vibration-reducing response of said second layer, and where the interface between said first and second foam layers is located such that both layers are continuously interposed between the spineboard and the litter across the extent of the pad.

16. The vibration-damping pad of claim 15 for use when the ground-engaging structure of the spineboard has spineboard runners and ground structure ends,
wherein said pad extends beyond each of the ground structure ends and said pad upper surface includes:
upper surface troughs for engaging the spineboard runners to block lateral motion of the spineboard on said pad upper surface, and
pad end ledges for engaging the ground structure ends to block longitudinal motion of the spineboard on said pad upper surface.

17. The spineboard securing system of claim 16 wherein said pad upper surface is configured to position the spineboard off-center with respect to a width of said pad, thereby providing space on the litter alongside the spineboard to accept a portable ICU.

18. The vibration-damping pad of claim of claim 15 wherein the pad further comprises:
a third layer of vibration-damping foam, where the vibration-damping response of said third layer is different than the vibration-reducing responses of said first and second layers, and where said third layer extends so as to be continuously interposed between the spineboard lower surface and the litter.

19. The vibration-damping pad of claim 12 further comprising:
a pad head segment configured to mateably engage a first portion of the spineboard lower surface that underlies the head of a patient when in use; and
a pad foot segment configured to mateably engage a portion of the spineboard lower surface that is spaced apart from the portion engaged by said pad head segment and underlies the feet of a patient when in use.

20. The spineboard securing system of claim 12 further comprising:
a layer of vibration-reducing gel that extends so as to be continuously interposed between the spineboard lower surface and the litter.
